(19) United States
(12) Patent Application Publication
(10) Pub. No.: US 2016/0291661 A1
(43) Pub. Date: Oct. 6, 2016

(54) INFORMATION CLEARING SYSTEM

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: KE-YOU HU, Shenzhen (CN)

(21) Appl. No.: 14/697,041

(22) Filed: Apr. 27, 2015

(30) Foreign Application Priority Data
Mar. 31, 2015 (CN) 201510147063.4

(51) Int. Cl. G06F 1/26

(52) U.S. Cl. CPC G06F 1/263

(57) ABSTRACT

An information clearing system for providing power supply for a south bridge chip includes a power supply unit and a jumper. The power supply unit includes an internal power supply and is configured to receive an external power supply. The jumper includes a cap and a base. The base includes a first pin, a second pin, and a third pin. When the system malfunctions and needs to clear CMOS information in the south bridge chip, the cap is positioned on the second pin and the third pin of the base, the external power supply and the internal power supply both cannot be provided to the south bridge chip, the south bridge chip is grounded via the second pin and the third pin of the base, and the CMOS information in the south bridge chip is cleared.

### CROSS-REFERENCE TO RELATED APPLICATIONS

This application claims priority to Chinese Patent Application No. 201510147063.4 filed on Mar. 31, 2015, the contents of which are incorporated by reference herein in its entirety.

### FIELD

The subject matter herein generally relates to an information clearing system.

### BACKGROUND

In electronics and particularly in computer electronics, jumpers are typically used to set up or adjust printed circuit boards, such as the motherboards of computers. Jumpers are often used on a motherboard to maintain power supply to a south bridge thus safeguarding stored complementary metal-oxide-semiconductor (CMOS) information. Further, the jumpers may be moved to invoke a function to clear the CMOS information in the south bridge, and reset the basic input output system (BIOS) configuration settings, which allows the computer to boot if a recent BIOS setting made it unable to boot, or if the CMOS boot password was forgotten. A button cell is fixed on the motherboard and provides power supply for the south bridge when an external power supply is cut off. When the south bridge needs to clear the CMOS information, the button cell needs to be disassembled from the motherboard.

### BRIEF DESCRIPTION OF THE DRAWINGS

Implementations of the present technology will now be described, by way of example only, with reference to the attached figures.

FIG. 1 is a block diagram of an embodiment of an information clearing system.

FIG. 2 is a circuit diagram of the information clearing system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like. “Unit” means a collection of electronic hardware alone or in combination with software configured for a particular task or function, although units may overlap or share components.

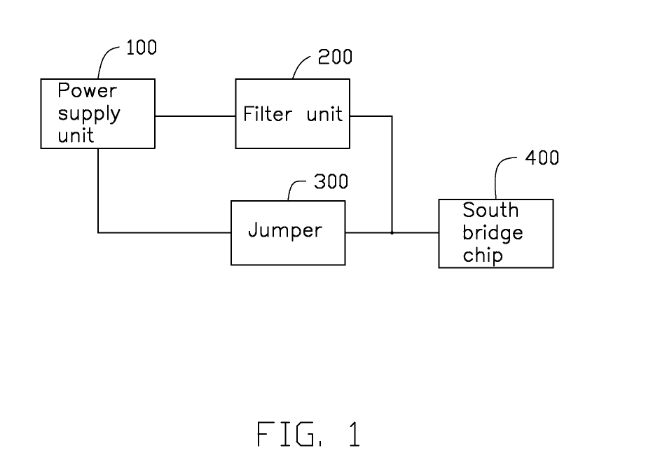

FIG. 1 illustrates an information clearing system in accordance with one embodiment. The information clearing system includes a power supply unit 100, a filter unit 200, and a jumper 300. The information clearing system is configured to provide power supply for a south bridge chip 400 and clear CMOS information in the south bridge chip 400 when the system is reset.

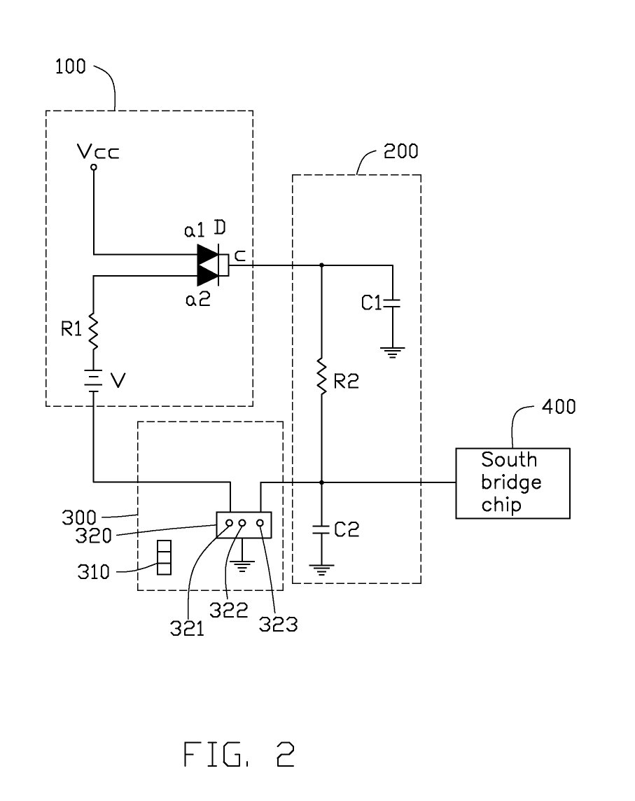

FIG. 2 illustrates that the jumper 300 includes a cap 310 and a base 320. The base 320 includes a first pin 321, a second pin 322, and a third pin 323. The power supply unit 100 includes a Schottky diode D, a first resistor R1, and an internal power supply V. The Schottky diode D includes a first anode a1, a second anode a2, and a cathode c. The first anode a1 of the Schottky diode D is configured to receive an external power supply Vcc. The second anode a2 of the Schottky diode D is electrically coupled to an anode of the internal power supply V via the first resistor R1 . A cathode of the internal power supply V is electrically coupled to the first pin 321 of the base 320. The second pin 322 of the base 320 is grounded.

In at least one embodiment, the external power supply Vcc is +3.3 volts, and the internal power supply V is a button cell.

The filter unit 200 includes a second resistor R2, a first capacitor C1, and a second capacitor C2. A first terminal of the second resistor R2 is electrically coupled to the cathode c of the Schottky diode D. The first terminal of the second resistor R2 is grounded via the first capacitor C1. A second terminal of the second resistor R2 is grounded via the second capacitor C2. The second terminal of the second resistor R2 is electrically coupled to the third pin 323 of the base 320 and the south bridge chip 400 respectively.

When the system is working normally, the cap 310 is positioned on the first pin 321 and the second pin 322 of the base 320. If the power supply is turned on, the external power supply Vcc is provided to the south bridge chip 400 via the Schottky diode D and the filter unit 200. If the power supply is cut off, the external power supply Vcc cannot be provided to the south bridge chip 400, the cathode of the internal power supply V is grounded via the first pin 321 and the second pin 322 of the base 320, the internal power supply V is provided to the south bridge chip 400 via the first resistor R1, the Schottky diode D, and the filter unit 200. Therefore, the CMOS information in the south bridge chip 400 will not be lost if the power supply is cut off.

When the system malfunctions and needs to clear the CMOS information in the south bridge chip 400, the cap 310 is positioned on the second pin 322 and the third pin 323 of the base 320. If the power supply is cut off, the external power supply Vcc cannot be provided to the south bridge chip 400, the cathode of the internal power supply V cannot be grounded and is cut off, the internal power supply V cannot be provided to the south bridge chip 400, the south bridge chip 400 is grounded via the second pin 322 and the third pin 323 of the base 320. Therefore, the CMOS information in the south bridge chip 400 is absolutely cleared and the internal power supply V does not need to be disassembled from the system.

The embodiments shown and described above are only examples. Many details are often found in the art such as the other features of an information clearing system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An information clearing system for providing power supply for a south bridge chip comprising:
a power supply unit comprising an internal power supply and configured to receive an external power supply; and
a jumper comprising a cap and a base, the base comprising a first pin, a second pin, and a third pin,
wherein when the system works normally, the cap is positioned on the first pin and the second pin of the base, if the power supply is turned on, the external power supply is provided to the south bridge chip, and if the power supply is cut off, the internal power supply is provided to the south bridge chip;
wherein when the system malfunctions and needs to clear CMOS information in the south bridge chip, the cap is positioned on the second pin and the third pin of the base, the external power supply and the internal power supply both cannot be provided to the south bridge chip, the south bridge chip is grounded via the second pin and the third pin of the base, and the CMOS information in the south bridge chip is cleared.

2. The information clearing system of claim 1, wherein the power supply unit further comprises a Schottky diode and a first resistor; the Schottky diode comprises a first anode, a second anode, and a cathode; the first anode of the Schottky diode is configured to receive the external power supply; the second anode of the Schottky diode is electrically coupled to an anode of the internal power supply via the first resistor; a cathode of the internal power supply is electrically coupled to the first pin of the base; and the second pin of the base is grounded.

3. The information clearing system of claim 2, wherein the external power supply is +3.3 volts, and the internal power supply is a button cell.

4. The information clearing system of claim 2, further comprising a filter unit; the filter unit comprises a second resistor, a first capacitor, and a second capacitor; a first terminal of the second resistor is electrically coupled to the cathode of the Schottky diode; the first terminal of the second resistor is grounded via the first capacitor; a second terminal of the second resistor is grounded via the second capacitor; and the second terminal of the second resistor is electrically coupled to the third pin of the base and the south bridge chip respectively.

5. The information clearing system of claim 4, wherein when the cap is positioned on the first pin and the second pin of the base, if the power supply is turned on, the external power supply is provided to the south bridge chip via the Schottky diode and the filter unit, and if the power supply is cut off, the external power supply cannot be provided to the south bridge chip, the cathode of the internal power supply is grounded via the first pin and the second pin of the base, the internal power supply is provided to the south bridge chip via the first resistor, the Schottky diode, and the filter unit.

6. The information clearing system of claim 4, wherein when the cap is positioned on the second pin and the third pin of the base, if the power supply is cut off, the external power supply cannot be provided to the south bridge chip, the cathode of the internal power supply cannot be grounded and is cut off, and the internal power supply cannot be provided to the south bridge chip.

7. An information clearing system comprising:
a power supply unit comprising an internal power supply and configured to receive an external power supply;
a jumper comprising a cap and a base, the base comprising a first pin, a second pin, and a third pin; and
a south bridge chip electrically coupled to the power supply unit via the jumper;
wherein when the system works normally, the cap is positioned on the first pin and the second pin of the base, if the power supply is turned on, the external power supply is provided to the south bridge chip, and if the power supply is cut off, the internal power supply is provided to the south bridge chip;
wherein when the system malfunctions and needs to clear CMOS information in the south bridge chip, the cap is positioned on the second pin and the third pin of the base, the external power supply and the internal power supply both cannot be provided to the south bridge chip, the south bridge chip is grounded via the second pin and the third pin of the base, and the CMOS information in the south bridge chip is cleared.

8. The information clearing system of claim 7, wherein the power supply unit further comprises a Schottky diode and a first resistor; the Schottky diode comprises a first anode, a second anode, and a cathode; the first anode of the Schottky diode is configured to receive the external power supply; the second anode of the Schottky diode is electrically coupled to an anode of the internal power supply via the first resistor; a cathode of the internal power supply is electrically coupled to the first pin of the base; and the second pin of the base is grounded.

9. The information clearing system of claim 8, wherein the external power supply is +3.3 volts, and the internal power supply is a button cell.

10. The information clearing system of claim 8, further comprising a filter unit; the filter unit comprises a second resistor, a first capacitor, and a second capacitor; a first terminal of the second resistor is electrically coupled to the cathode of the Schottky diode; the first terminal of the second resistor is grounded via the first capacitor; a second terminal of the second resistor is grounded via the second capacitor; and the second terminal of the second resistor is electrically coupled to the third pin of the base and the south bridge chip respectively.

11. The information clearing system of claim 10, wherein when the cap is positioned on the first pin and the second pin of the base, if the power supply is turned on, the external power supply is provided to the south bridge chip via the Schottky diode and the filter unit, and if the power supply is cut off, the external power supply cannot be provided to the south bridge chip, the cathode of the internal power supply is grounded via the first pin and the second pin of the base, the internal power supply is provided to the south bridge chip via the first resistor, the Schottky diode, and the filter unit.

12. The information clearing system of claim 10, wherein when the cap is positioned on the second pin and the third pin of the base, if the power supply is cut off, the external power supply cannot be provided to the south bridge chip, the cathode of the internal power supply cannot be grounded and is cut off, and the internal power supply cannot be provided to the south bridge chip.

13. An information clearing system for a south bridge chip comprising:
a power supply having an internal power supply and receiving an external power supply;
a Schottky diode having a first anode connected to the external power supply, a second anode coupled to the internal power supply and cathode connected to the first anode and to the second anode;
a jumper having a cap and a base, with the base having a first pin, a second pin and a third pin; and
a filter connected to the cathode, the third jumper pin and the south bridge chip;
wherein, the external power supply is activated, the cap is positioned on the first pin and the second pin and the external power supply is delivered to the south bridge chip; and
wherein, when the external power supply is deactivated, the cap repositions to the second pin and the third pin and the south grounded through the second and third pins.
